(19) United States
(12) Patent Application Publication
(10) Pub. No.: US 2019/0339936 A1
(43) Pub. Date: Nov. 7, 2019

(54) SMART MIRROR

(71) Applicant: Imam Abdulrahman Bin Faisal University, Dammam (SA)

(72) Inventors: Samiha Brahimi, Dammam (SA); AlHanouf Ali O. Alotaibi, Dammam (SA); Jana Alkordy, Dammam (SA); Nouf Albuali, Dammam (SA); Doha Asiri, Dammam (SA); Norah Alkhuwaiter, Dammam (SA)

(73) Assignee: Imam Abdulrahman Bin Faisal University, Dammam (SA)

(21) Appl. No.: 15/973,222

(22) Filed: May 7, 2018

(51) Int. Cl. G06F 3/16; G06F 3/147; G10L 15/22; G02B 27/14

(52) U.S. Cl. CPC G06F 3/167; G06F 3/147; G06F 17/212; G02B 27/14; G10L 15/22

(57) ABSTRACT

A mirror apparatus has a reflective panel with a front surface and an opposing back surface. A display device faces the back surface of the reflective panel such that information rendered on the display device is conveyed to the front surface of the reflective panel. Processor circuitry accepts a voice command from a user and renders the information on the display in accordance with constraints of an interface selected based on the voice command.

### BACKGROUND OF THE INVENTION

### Technical Field

The present disclosure relates to smart devices, i.e., electronic devices that are generally connected to other devices or networks via typically wireless communication protocols. Specifically, the disclosure is directed to a smart mirror.

### Description of the Related Art

Advancements in information storage, information transmission and computation, among other things, have transformed the way in which modern people conduct their lives. Today, in the Information Age, massive amounts of information can be leveraged by individuals to explore their personalized needs and interests. The drive towards having information readily available has led to efforts to make ubiquitous computing a reality, and has led to an explosion in the variety of so-called “smart” devices, which, as used herein, refers to an electronic device that is generally connected to other devices or networks via typically wireless communication protocols. Today's smart devices include thermostats, home lighting panels and home appliances in what are referred to as smart houses or smart homes. Such smart home devices can be remotely monitored and controlled via the Internet and are important constituents of the Internet of Things (IoT).

Human activities in front of a mirror have long included preparing for the day; during which people often think about immediate events or something important e.g. schedule of the day, weather forecasting at today's destination, etc., while performing something else. This indicates the acceptability of presenting information on the mirror in a manner by which a user is informed, while not being overwhelmed or generally distracted from the task at hand.

### SUMMARY OF THE INVENTION

In one embodiment the present disclosure relates to a mirror apparatus having a reflective panel with a front surface and an opposing back surface. A display device faces the back surface of the reflective panel such that information rendered on the display device is conveyed to the front surface of the reflective panel. Processor circuitry accepts a voice command from a user and renders the information on the display in accordance with constraints of an interface selected based on the voice command.

In a further embodiment, the processor is further configured to determine whether a command is valid, constrain the information to an error message upon determination that the command is invalid, and/or render the information on the display through an error interface.

In a further embodiment, communications circuitry is included and is configured to couple to at least one information service through a communications network.

In a further embodiment, the processor is further configured to obtain the information from the information service through the communications circuitry and/or render the obtained information on the display upon determining that the voice command is valid.

In a further embodiment, the processor is further configured to analyze the data from the information service, select a visualization of the data based on the analysis, and/or format the data as the information in accordance with the selected visualization.

In a further embodiment, an immutable identifier is included by which the apparatus is identified as an entity on the Internet.

In a further embodiment, the processor is further configured to accept configuration information through the communications circuitry from an external device, and/or obtain the data from only information services specified in the configuration information.

### BRIEF DESCRIPTION OF THE DRAWINGS

FIG. 1 is a schematic block diagram of an example system in which the present inventive concept can be embodied.

FIG. 2 is an illustration of a mechanical configuration by which the present inventive concept can be embodied.

FIG. 3 is a block diagram of information services with which the present inventive concept can be embodied.

FIG. 4 is a block flow diagram of data flow in embodiments of the present inventive concept.

FIGS. 5A-5O are illustrations of user interface components with which the present inventive concept can be embodied.

FIG. 6 is a schematic block diagram of communication interfaces with which the present inventive concept can be embodied.

FIG. 7 is a diagram of example hardware by which the present inventive concept can be embodied.

FIG. 8 is a block diagram of a reference model of an embodiment of the present inventive concept.

FIG. 9 is a diagram of voice recognition of an embodiment of the present inventive concept.

FIG. 10 is a diagram illustrating functional aspects of an embodiment of the present inventive concept.

FIG. 11 is a diagram of an example state machine by which the present inventive concept can be embodied.

FIG. 12 is a flow diagram of mirror functionality of an embodiment of the present inventive concept.

FIG. 13 is a diagram of backend processing of an embodiment of the present inventive concept.

FIG. 14 is a diagram of other backend processing of an embodiment of the present inventive concept.

FIG. 15 is a sequence diagram of communication with an information service in an embodiment of the present inventive concept.

FIG. 16 is a sequence diagram of other communication with an information service in an embodiment of the present inventive concept.

FIG. 17 is a sequence diagram of communication with another information service in an embodiment of the present inventive concept.

FIG. 18 is a sequence diagram of communication with another information service in an embodiment of the present inventive concept.

FIG. 19 is a schematic block diagram of another system in which the present inventive concept can be embodied.

### DETAILED DESCRIPTION OF EMBODIMENTS

The present system and apparatus is described through certain embodiments thereof, which are described in detail herein with reference to the accompanying drawings, wherein like reference numerals refer to like features throughout. It is to be understood that the term invention, when used herein, is intended to connote the inventive concept underlying the embodiments described below and not merely the embodiments themselves. It is to be understood further that the general inventive concept is not limited to the illustrative embodiments described below and the following descriptions should be read in such light.

Additionally, the word exemplary is used herein to mean, “serving as an example, instance or illustration.” Any embodiment of construction, process, design, technique, etc., designated herein as exemplary is not necessarily to be construed as preferred or advantageous over other such embodiments. Particular quality or fitness of the examples indicated herein as exemplary is neither intended nor should be inferred.

The present invention may be embodied in a smart mirror that not only reflects a user's image on its surface, but also displays information that the user would find relevant or interesting. The smart mirror embodiment of the present invention responds to vocal commands issued by the user and may be an entity or “thing” on the Internet of Things (IoT).

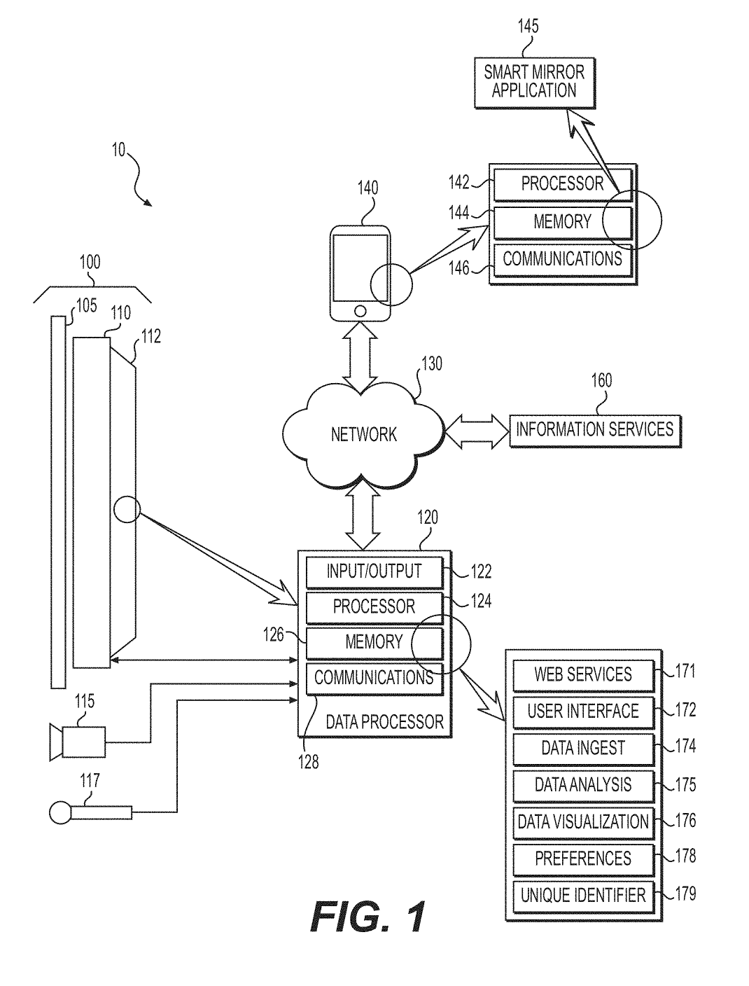

FIG. 1 is a schematic block diagram of an exemplary system 10 in which the present invention can be embodied. System 10 includes smart mirror 100, viewed from the side in FIG. 1, comprising a reflective overlay 105, a display device 110 and a housing 112 enclosing data processor circuitry 120. As illustrated in FIG. 1, data processor circuitry 120 may comprise input/output (I/O) circuitry 122, processor circuitry 124, memory circuitry 126 and communications circuitry 128. These resources may be utilized to realize web services 171 to implement the hyper-text transfer protocol (HTTP) at the application layer and may include both web server services and web browser services. In one embodiment, an onboard browser implements the visual components of user interface 172 and may allow access preferences 178 stored in memory 126, in accordance with which data are displayed on display device 110. Preferences 178 may also establish other control functionality as those having skill in the art will appreciate.

User interface 172 may include a graphical user interface that presents data formatted from data ingest process 174. For example, presentation processing 176 may format data retrieved from information services 160 by data ingest process 174 in accordance with preferences 178 configured by a user.

Unique identifier 179 may be may be an immutable identifier used to locate and connect to smart mirror 100 through IoT. In one embodiment, unique identifier 179 is realized through radio frequency identification (RFID) or similar tag utilized by a smart mirror application 145 executing on processing resources, processor circuitry 142, memory circuitry 144 and communications circuitry 146 of data processing device 140. For purposes of explanation and not limitation, data processing device 140 may be referred to herein as smartphone 140, although data processing device 140 need not be a mobile device.

Smart mirror application 145 may provide an interface to smart mirror 100 for purposes of setting preferences for an individual user and/or for operating smart mirror 100 remotely. One such preference may be to activate smart mirror 100, e.g., display user content thereon, based on environmental cues that indicate a user may be about to view smart mirror 100, such as when the user is first waking up for the day. For example, the user may establish a preference to activate smart mirror 100 when curtains are opened (perhaps by a “smart house” application on smartphone 140) to reveal daylight, an indication that the user may be rising from sleep. A preference may also be established through smart mirror application 145 to deactivate smart mirror 100 when the user is ready to go to bed, such as when lights are turned off or curtains are closed. Other preferences may be implemented as well and machine learning techniques may be implemented by which smart mirror 100 learns a user's mirror using habits and activates/deactivates smart mirror 100 accordingly.

Smart mirror 100 may be communicatively coupled to one or more information services 150 from which data ingest process 175 obtains data. The data may be analyzed by data analysis process 175, whereby characteristics of the data are determined. The results of the analysis may be provided to data visualization process 176, whereby an appropriate data visualization is selected based on the characteristics of the data. The present invention is not limited to particular data visualization techniques; those having skill in the art will recognize numerous data visualization techniques and data visualization tools that may be used in conjunction with the present invention without departing from the spirit and intended scope thereof.

Smart mirror 100 may include additional equipment or sensors by which the user experience is improved. For example, smart mirror 115 may include a camera 115 and a microphone 117 that interact with user interface 172 for purposes of, for example, face recognition, detecting when a user is present before smart mirror 100, voice command recognition, etc. Facial recognition may be achieved through a suitable techniques, such as that implemented by the commercially available facial recognition tool KAIROS.

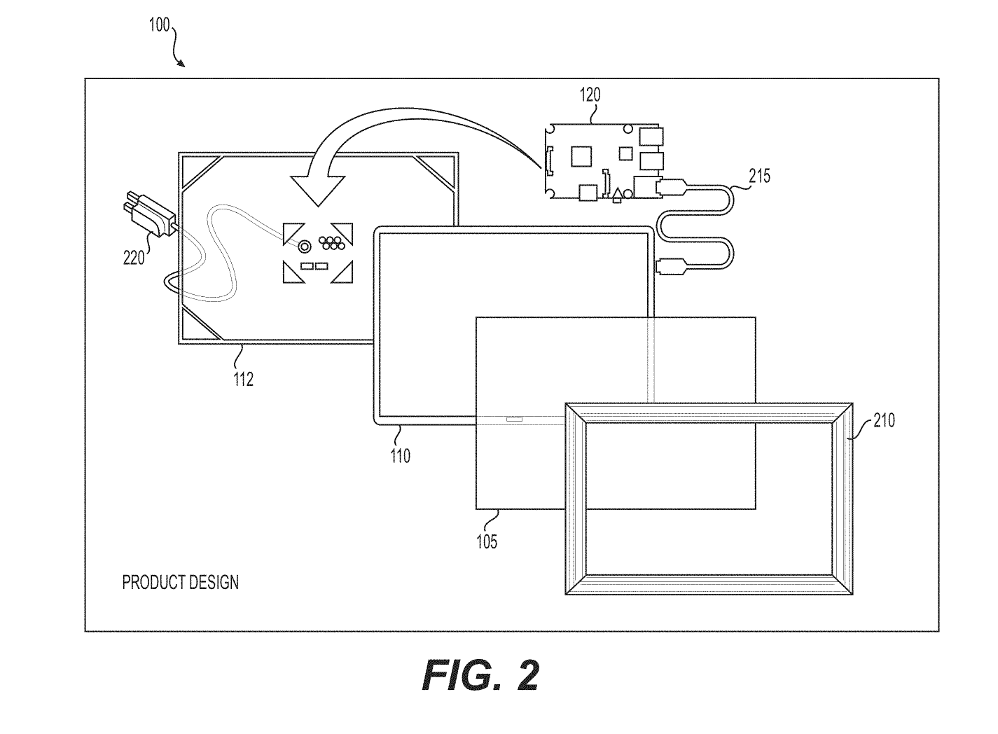

FIG. 2 is an illustration of an exploded view of example hardware components of smart mirror 100. Housing 112 may be constructed from a suitable material such as metal or plastic so as to enclose processing circuitry 120 while attached to display device 110. Housing 112 may have several openings formed therein to accommodate various sensors, communication ports, etc. For example, housing 112 or, in some embodiments, frame 210 may have an opening for a forward-facing (towards the user) microphone and/or a USB port for attaching a keyboard and/or mouse.

Processing circuitry 120 may be a single-board computer (SBC), such as a RASPBERRY PI, or similar circuitry that possesses the hardware and software functionality to perform the operations described herein. Display device 110 may be a computer monitor communicatively coupled to processing circuitry 120 through a cable 210, such as a high definition multimedia interface (HDMI) cable. Power to display device 110 may be provided through power cord 225, which may also be connected to a power supply (not illustrated) from which processing circuitry 120 derives operating power.

Reflective overlay 105 may be a partially-reflective sheet having a front surface and an opposing back surface such that images displayed on display device 110 are conveyed through the front surface of reflective overlay 105. Reflective overlay 105 may be suitably attached to display device 110, such as by an adhesive through connection to an optional decorative frame 210. In one embodiment, reflective overlay 105 is a semi-transparent acrylic sheet material that is transparent from the darker side. That is, the sheet acts as a mirror from a lighted side and is transparent from the less lighted side. Accordingly, high contrast, bright items on display device 110 will be visible to the viewer through reflective overlay 105, while dark fields on display device 110 will be reflective to the viewer, provided the room in which smart mirror 100 is well lit. In certain embodiments, reflective overlay 105 is flexible, so as to accommodate a touch screen monitor of display device 110. In other embodiments, reflective overlay 105 may be rigid.

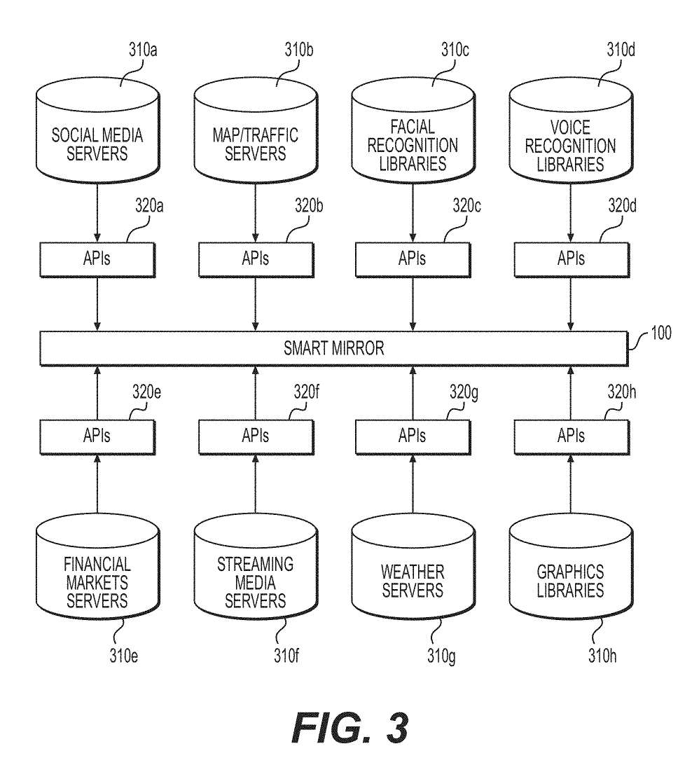

FIG. 3 is a diagram of example big data that can be used in conjunction with embodiments of the present invention as information services 160. Smart mirror 100 may be constructed or otherwise configured to ingest, analyze, format and display data from social media servers 310a through application programming interface 320a, map/traffic servers 310b through application programming interface 320b, facial recognition libraries 310c through application programming interface 320c, voice recognition libraries 310d through application programming interface 320d, financial markets servers 310e through application programming interface 320e, streaming media servers 310f through application programming interface 320f, weather servers 310g through application programming interface 320g and graphics libraries 310h through application programming interface 320h. For purposes of succinctness, data services/libraries 310a-310h may be representatively referred to herein as service(s) 310 and APIs 320a-320h may be representatively referred to herein as API(s) 320. It is to be understood that other information services/libraries can be used with embodiments of the present invention without departing from the spirit and intended scope thereof. Specific examples of information services that might be used in embodiments of the invention are provided below.

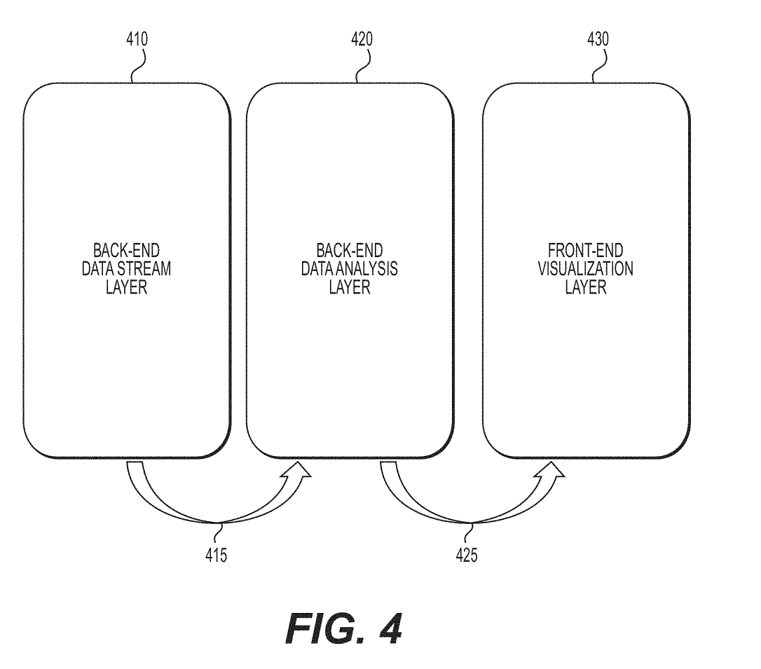

FIG. 4 is a block flow diagram of internal data flow in embodiments of the present invention. Smart mirror 100 may be considered a big data platform that filters streamed data arriving via the APIs 320. The connection between smart mirror 100 and APIs 320 must first be established to stream data. This communication may be secured with a token specified by each API 320, which may be associated with specific terms of use for the information service. Once the connection has been established, predefined libraries and variables associated with the respective APIs 320 may be utilized in data ingest layer 410 to acquire data from respective services 310 in a data stream. Data analysis layer 420 may process data stream 415 using different processes to produce information 425 meaningful to the user. Visualization layer 430 may render the processed information 425 on display device 110. Some information may be ready to visualize immediately without any alteration, while other data may be processed into a usable statistical form of data that is provided on user interface 172. Data output results are shown simultaneously on user interface 172: trending topics, news headlines, crowded places (traffic) and weather information. The output may be portrayed in the form of charts or graphs. Visualization layer 430 may be realized in JAVASCRIPT code running in a browser, which issues requests to APIs for information, as well as responding to user input such as search queries.

In certain embodiments, smart mirror 100 utilizes two types of script: server side script and client side script. Server side scripting is used to communicate with APIs 320 and include JAVA, PYTHON and JAVASCRIPT (e.g., node.js library) while the client side scripting resides in the client browser using JAVASCRIPT and cascade style sheets (CSS) in data visualization. For each API 320, there are specific libraries and packages that are used to communicate with various APIs 320; node.js an open source JAVASCRIPT library for real time web applications and D3.js which is a JAVASCRIPT data visualization library. Other packages will be apparent to those having skill in the art.

Visualization layer 430 may be implemented through external tools that provide means to construct information in presentable graphics. The way that information is represented is different from one API to another. For example, data retrieved from DARK SKY API, a weather information service, do not need an independent visualization tool. Weather information will be displayed as icons (sunny, cloudy, rainy, etc.) which are swapped as weather conditions change. This technique is embedded in source code and will be interpreted as the software executes.

In certain embodiments, information is revealed in appropriate order by giving the user the choice to enlarge the desired figure. Contents of user interface 172 should be organized in a manner by which the user will not be overwhelmed. Information may be displayed in a logical form; relevant information is grouped together such as date and weather, news and figures. The content of user interface 172 is arranged so as to not interfere with the area dedicated for regular mirror use. Attention of the user should be drawn to the main information by manipulating several factors like colors, contrast, position and size. The contents of user interface 172 are displayed using familiar and well-known icons and charts to support the user understanding and learning process. User effort is minimized by giving full control over smart mirror 100 using voice commands. User interface 172 may direct the user to make the final decision by giving some suggestion thereon. For example, if the weather analysis shows that today will be rainy, a message may be shown to suggest wearing a rain jacket. The information shown on user interface 172 is related to the location of the front-end user. Explanation of features for users to understand user interface 172 may be implemented through a demonstration interface provided at the beginning of use.

Backend processes 410, 420 work as an invisible layer to the end user. The processes receive incoming data stream from APIs 320 then filters the data entries, such as to remove redundant or incomplete records, and provides the filtered data to analysis and visualization layer. Analysis layer 420 will receive data transmitted through the channel to apply various algorithms to the data, e.g., computing statistics, tagging information, etc. to ready the data for visualization layer 430. Finally, the processed data will travel to visualization layer 430 to be presented as charts. The communication will terminate only if the mirror is closed.

User interface 172 may include a collection of web-based controls, such as in a browser, that are designed to provide information visually. User interface 172 may take the user voice command as input as well as the data stream from APIs 320. The graphics displayed on the user interface 172 will provide a visual representation of the output produced.

Briefly, an “Open mirror” voice command during presentation of a startup interface initiates a welcome interface. The welcome interface disappears and a dashboard home page is displayed. The dashboard continuously refreshes as new data are received from APIs 320. The “Home” voice command during presentation of a help interface or support interface or during zoomed operations restores the home dashboard interface. The support voice command compels the support interface to be displayed, while the help voice command compels the help interface to be displayed. The close mirror voice command compels the closing of the mirror and reveals the startup interface on the dashboard.

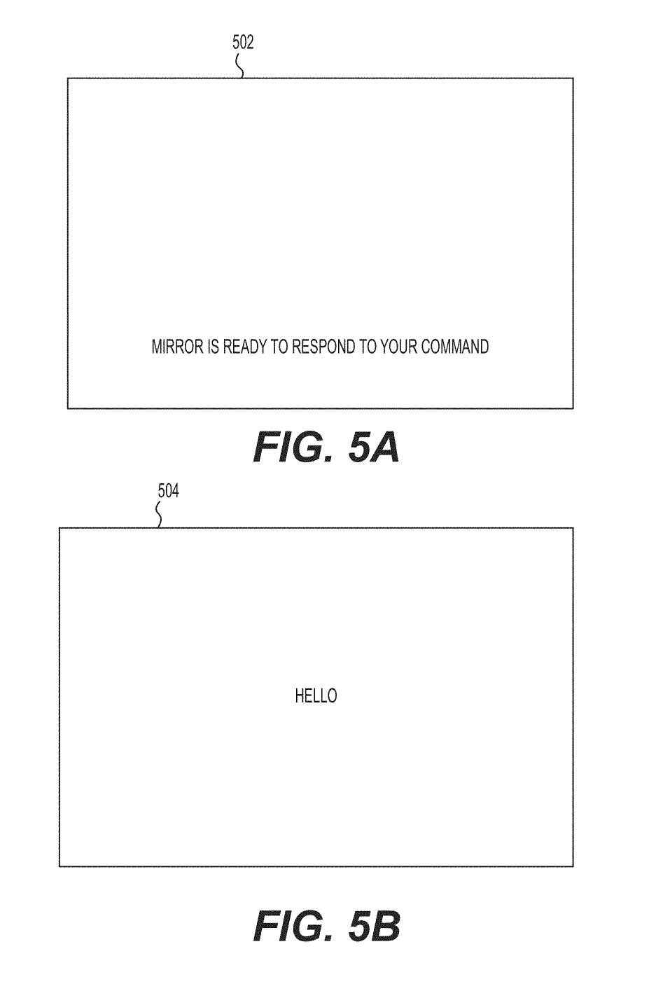

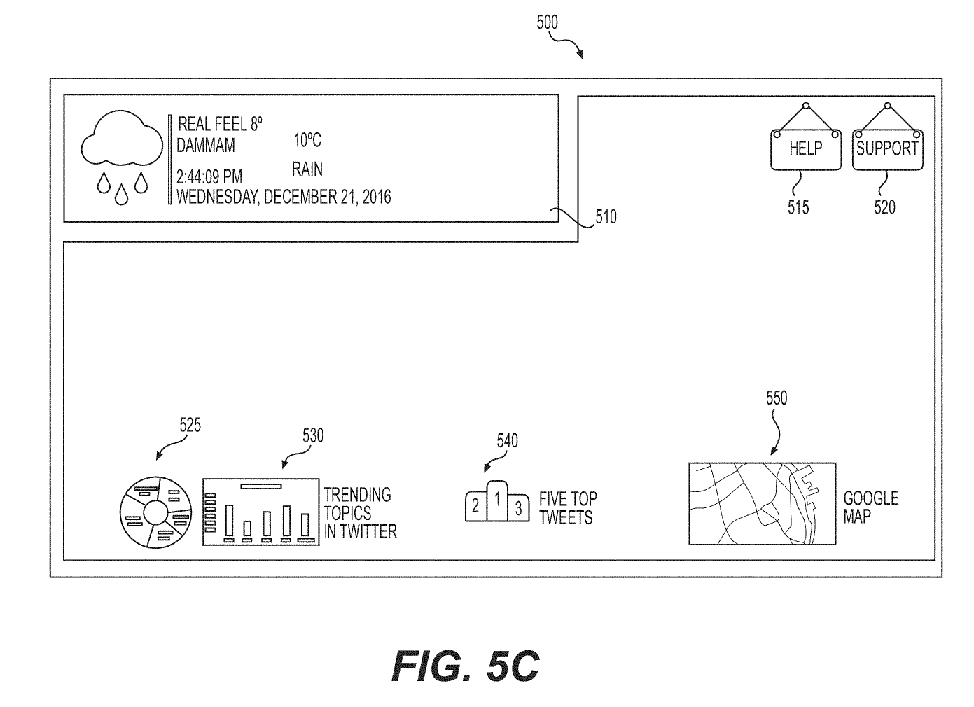

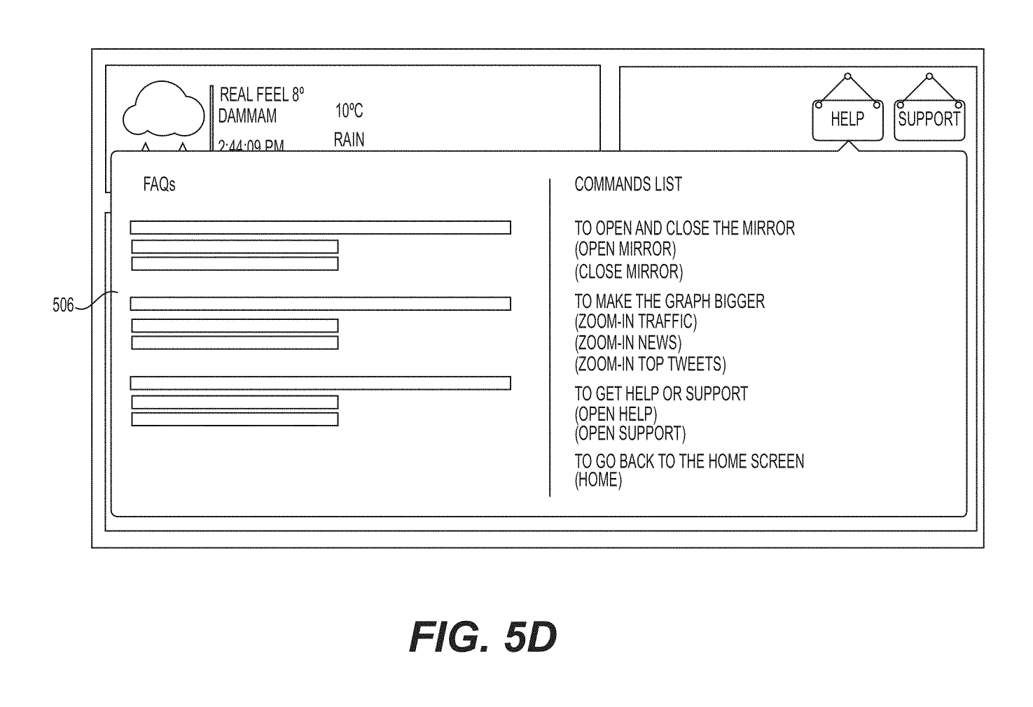

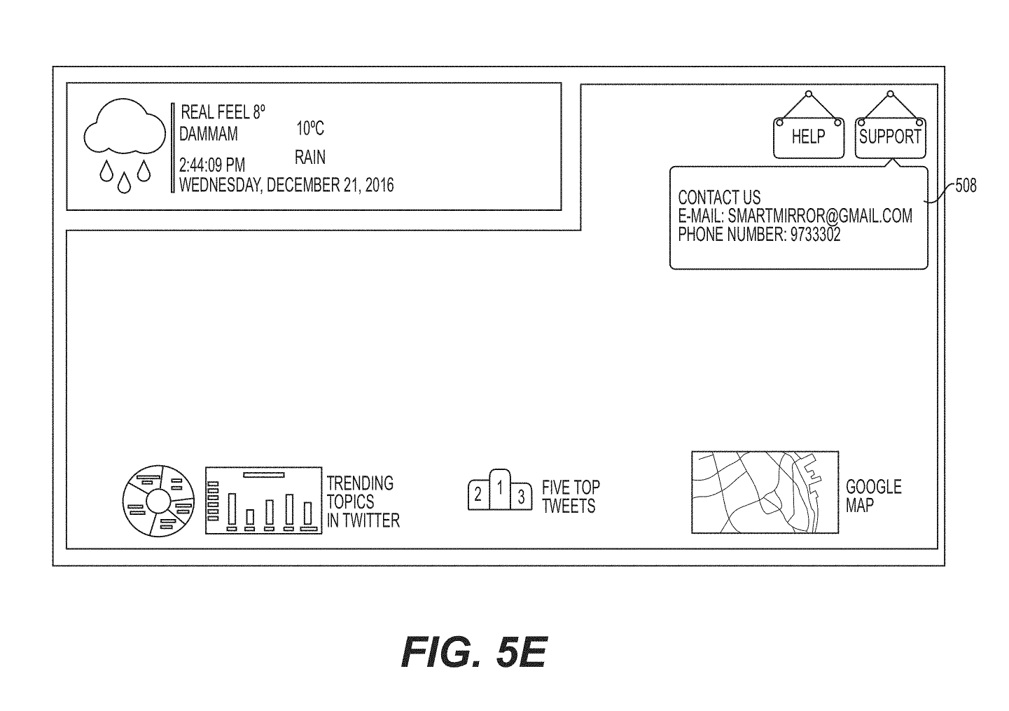

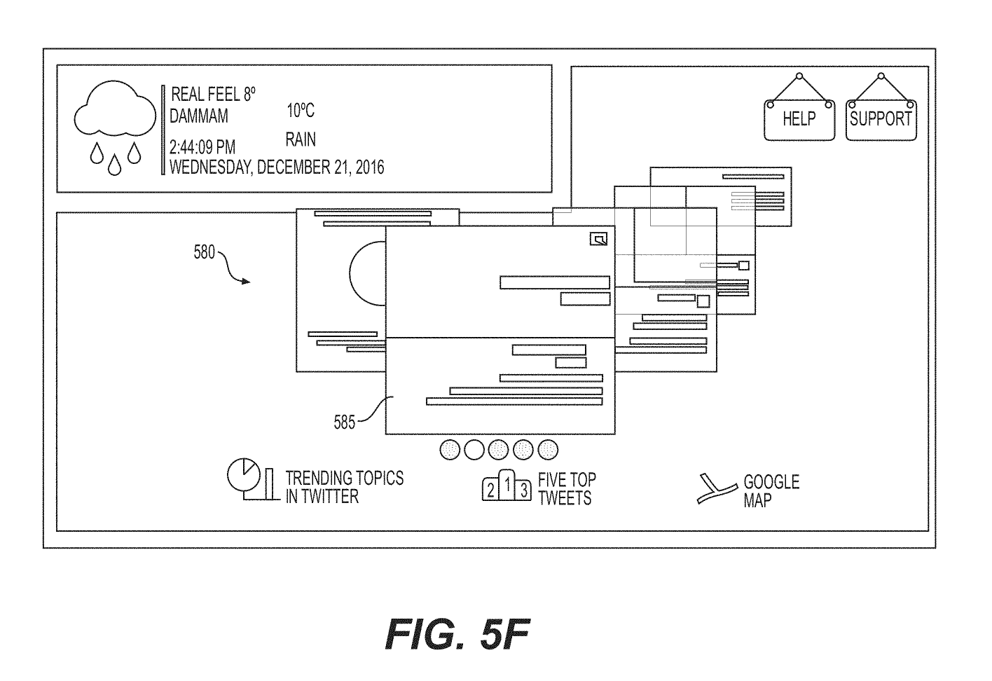

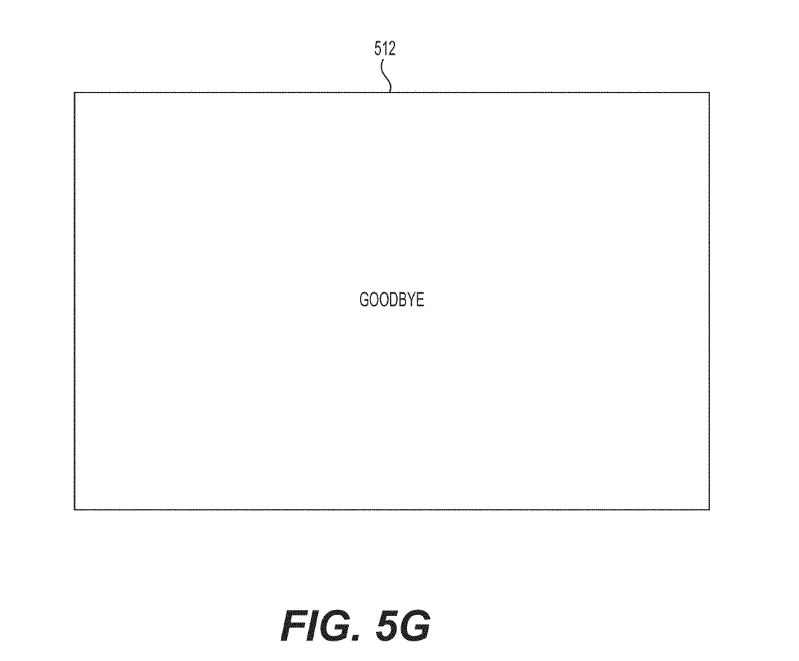

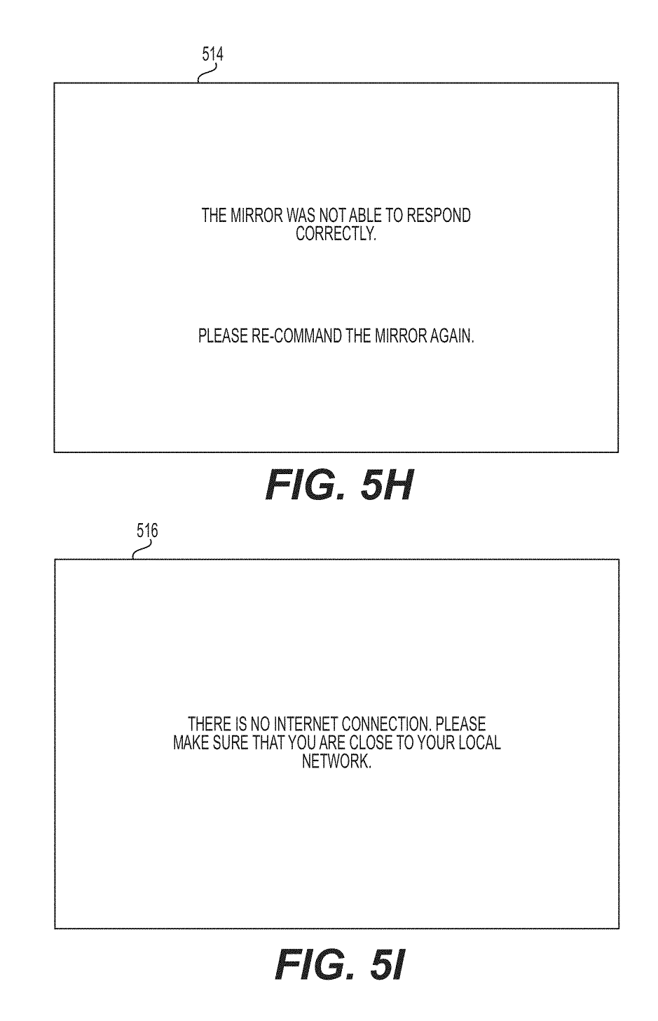

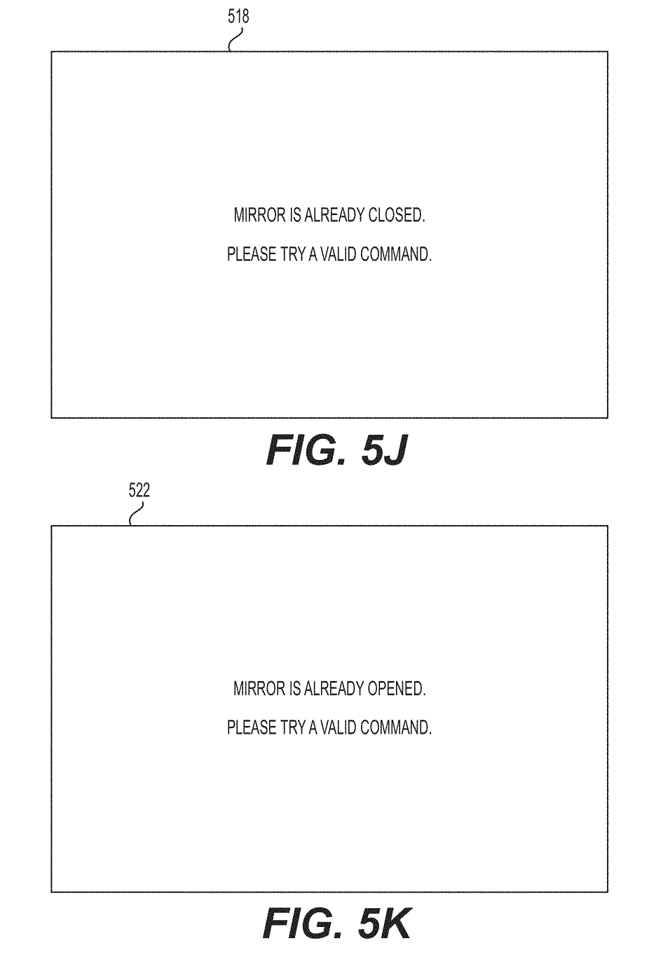

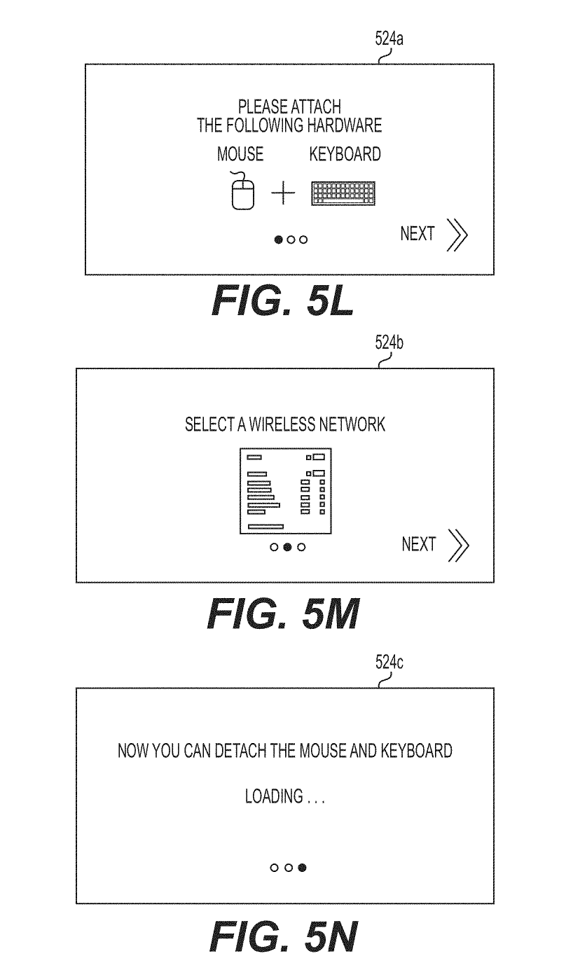

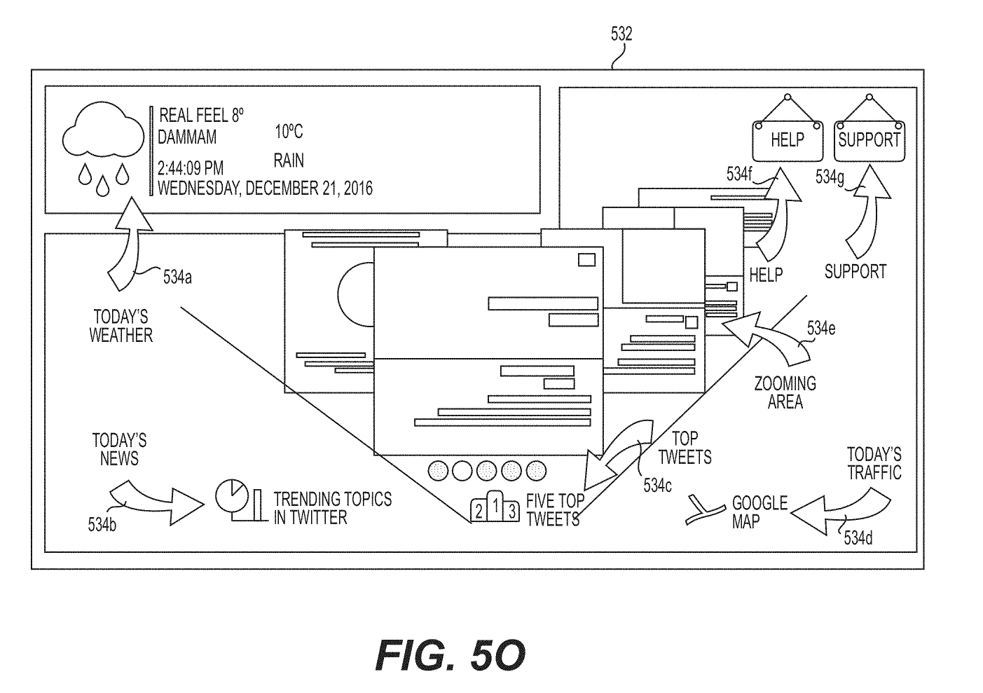

FIG. 5A is an illustration of an example startup interface 502, which is displayed upon successfully booting up smart mirror 100. Startup interface 502 indicates that smart mirror 100 is ready to receive a voice command. In certain embodiments, the interface does not change until and unless the user commands mirror with a suitable command such as “Hello mirror,” or “Open mirror.”

FIG. 5B is an illustration of an example welcome interface 504, which is displayed in response to an “Open mirror” command while startup interface 502 is displayed. This interface is displayed briefly prior to dashboard 500 (illustrated in FIG. 5C) being displayed.

FIG. 5C is an illustration of an example user dashboard 500. Dashboard home interface 500 is displayed automatically after the user welcome screen 504. It is mainly concerned with visualizing the analyzed data in the form of charts, e.g., pie charts, histograms, etc. Dashboard 500 may be divided into a grid with each grid section will contain one graphic. Dashboard 500 is constructed or otherwise configured with a color scheme that lends itself to be selectively viewed through reflective overlay 105. Dashboard 500 may also be divided into sections at which information from different sources are located. For example, as illustrated in FIG. 5A, dashboard 500 may have a weather/time section 510, a news section 525, social media sections 530 and 540 and traffic maps sections 550. It is to be understood that other sections may be incorporated into dashboard 500 according to user preferences 179.

Additionally, dashboard 500 may include sections by which a user can obtain help, such as by help control 515, and can contact support personnel, such as by support control 520. FIG. 5D illustrates an example help screen 506, which displays helpful instructions and a FAQ that guide the user during navigation. The help screen works as a user manual substitute. A user may access help screen 506 by suitable command, such as by a voice command, “Get help” or “Help.”

FIG. 5E illustrates an example support screen 508. Support interface will provide contact details for users to report malfunctions or additional features recommendations. A user may access support screen 508 by suitable command, such as by a voice command, “Get support” or “Support.”

FIG. 5F illustrates dashboard 500 in a zoom mode, whereby a portion of dashboard 500 is elaborated in response to a suitable command. Zoom-in command enlarges the desired graphic through a “Zoom-in <graphic>” vocal command. The graphic will return to preview size (e.g., icon or representative graphic) in response to a “Home” command. For example, a user may submit a voice command, “Zoom top 5 tweets,” and, in response the top five tweets 580 from TWITTER social media servers are displayed in detail and displayed prominently on dashboard 500. The user may zoom in on other sections of dashboard 500 by similar commands. Additionally, the user may navigate through the information, such as through a “Next” voice command, to view details, such as TWEET 585, within the zoomed information.

FIG. 5G is an illustration of an example exit interface 512, which is displayed in response to a “Close mirror” command. Exit interface 512 may be displayed briefly before startup interface 502 is displayed indicating that smart mirror 100 is in sleep mode. If the user wants to completely deactivate smart mirror 100, the user may remove power such as through a power switch or unplugging smart mirror 100 from its power source.

An error interface displays error information, such as when an invalid command is given, a command is not recognized or in the event of communications network errors. The error interface may also warn the user when smart mirror does not recognize an issued command and informs the user to issue a valid command.

FIG. 5H is an illustration of an example error interface 514, which may be presented in response to a voice command that is irrelevant or unclear. FIG. 5I is an illustration of an example error interface 516, which may be presented when a connection to the Internet could not be detected. When smart mirror is unable to connect to the internet via the Wi-Fi adapter, the error interface may inform the user that the Wi-Fi connection failed and that the mirror may have to be relocated to a new position in range of a Wi-Fi hot spot.

FIG. 5J is an illustration of an example error interface 518, which may be displayed when the front-end user commands smart mirror 100 with a “Close mirror” command while the mirror is closed. FIG. 5K is an illustration of an example error interface 518, which may be displayed when the front-end user commands smart mirror 100 with an “Open mirror” command while the mirror is open.

As illustrated in FIGS. 5L-5N, smart mirror 100 may implement a configuration interface 524 comprising interfaces 524a-524c, by which additional input devices may be connected to smart mirror 100. For example, in response to an inactive network connection, interface 524a may be presented by which the user is instructed to connect a mouse and keyboard to smart mirror 100. Once such has been achieved, interface 524b may be displayed by which the user may select a wireless network with which to connect and may enter the password for the wireless network. Other configuration parameters may be set through a similar interface. Interface 524c may be displayed after the network has been configured and, in response to the mouse and keyboard being disconnected, smart mirror 100 may display startup interface 502.

Configuration interfaces may be included in embodiments of the invention to allow support personnel to control the features accessible by general users. For example, support personnel can pin/unpin categories of news displayed on the dashboard, edit source code, add more voice commands, stream new data from new categories and manage analytical tools used for big data.

A demo interface may also be implemented in which graphics explaining salient smart mirror features are overlaid on the dashboard interface. This interface may be temporary so as to avoid annoying the user. FIG. 5O is an illustration of an example demonstration interface 532 in which components of dashboard 500 are indicated through corresponding graphical overlay elements 534a-534g. Demonstration interface 532 may be shown for the first time the user navigates through the dashboard contents and/or in response to a “Demo” voice command.

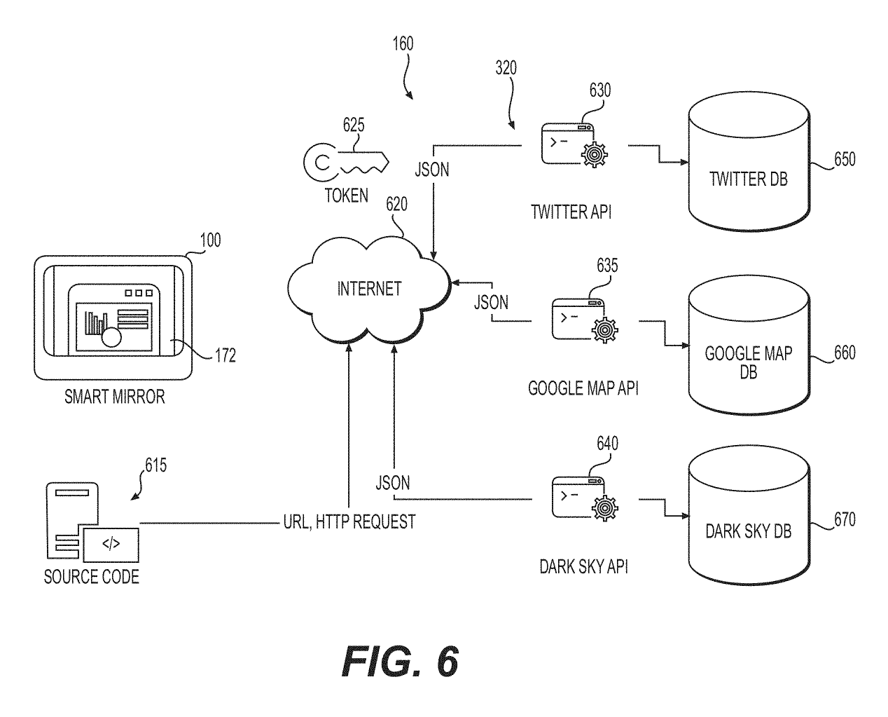

FIG. 6 is a schematic block diagram of communication interfaces that can be utilized in embodiments of the present invention. Smart mirror 100 may be connected to a local area network or hotspot for connection to the Internet 620. Using HTTP for communications on, for example, port 80 and Ipv4 format based logical address, smart mirror 100 may connect to APIs 320, e.g., TWITTER API 630 into TWITTER database (DB) 650, GOOGLE MAPS API 635 into GOOGLE MAPS DB 660 and DARK SKY API 640 into DARK SKY DB 670, to receive a stream of data generated by APIs 320 and the dashboard is updated accordingly. Smart mirror 100 may include the initialization code script in source code 615 for each API along with a token or key 625 for each API 320 to allow data streaming over the network. Smart mirror code 615 may run in a browser in order to send HTTP GET requests and to receive HTTP POST responses.

As is illustrated in FIG. 6, source code 615 on smart mirror 100 establishes a connection by sending an HTTP request over Internet 620 to the applicable information services 160. Smart mirror 100 may connect to Internet 620 via Wi-Fi. In the illustrated example, only three information services 690 are considered—TWITTER for social media, GOOGLE MAPS for traffic and DARK SKY for time and weather—although other services may be used in conjunction with the present invention without departing from the spirit and intended scope thereof.

Social websites are one of the chief sources for big data. TWITTER offers public APIs to make the TWITTER community more active. TWITTER is a useful source of big data for understanding current pop culture. TWITTER API supports different libraries from JAVA to PYTHON to RUBY. The streaming TWITTER API allows data to be retrieved using HTTP.

DARK SKY API is a JAVASCRIPT and PYTHON based API that allows users to retrieve weather data by using the current location and token. The token is generated in response to user registration. The DARK SKY API provides different types of libraries and features. The Forecast Request feature returns the current weather conditions and updates periodically.

GOOGLE provides web services for GOOGLE MAPS with different kinds of APIs. The JAVASCRIPT API is that used in smart mirror 100 and allows smart mirror 100 to retrieve a GOOGLE map based on current location by using a key generated via a GMAIL account. The GOOGLE MAP API has many features such as data visualization, choosing a map style, addition of marks and importing data to the map.

GOOGLE MAP API provides information of crowded places through a map. Localities are sent as a request with a specific region code in addition to a specified time interval. Later, GOOGLE MAPS API will respond with the requested map, which is displayed on user interface 172.

Data may be requested by a call to one or more of APIs 630, 635 and 640, which obtains the data from a corresponding database 650, 660 and 670 if the call is recognized as being secured by a security token or key 625. APIs 630, 635 and 640 may return the data to smart mirror 100 using JavaScript Object Notation (JSON).

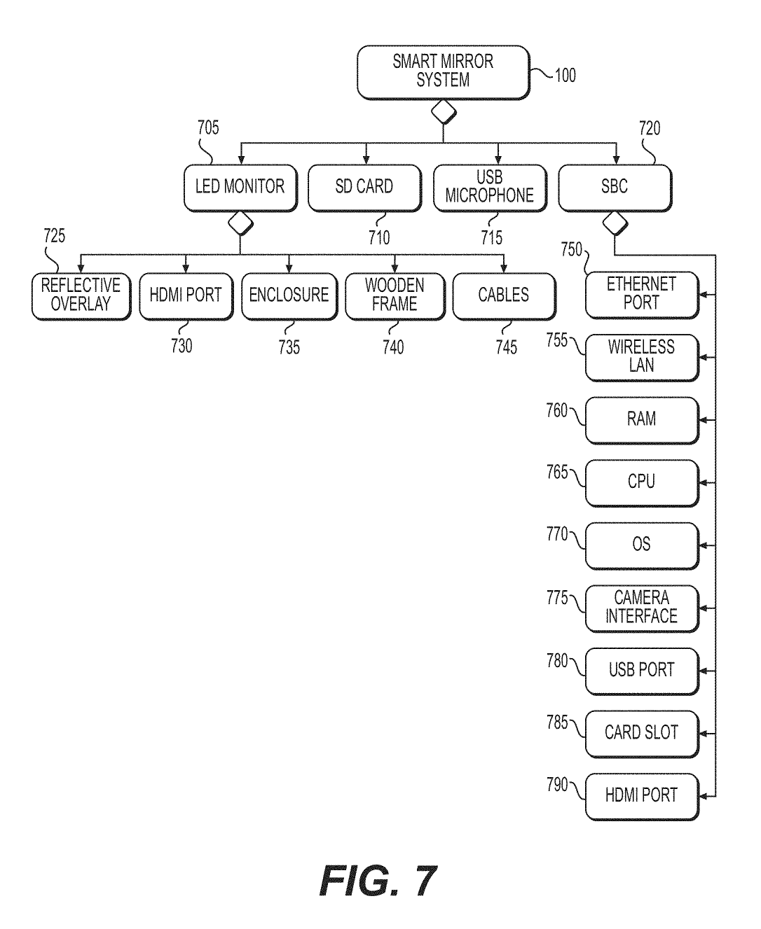

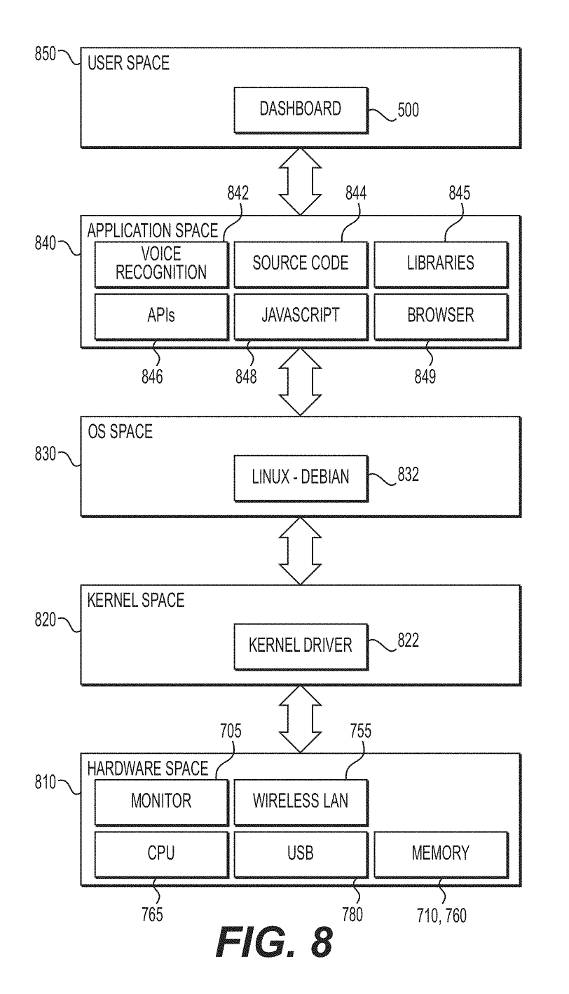

FIG. 7 is a diagram detailing an example hardware architecture of a smart mirror 100 by which the present invention can be embodied. Smart mirror 100 may comprise an LED monitor 705 as display device 110 and SBC 720, such as RASPBERRY PI, as processing circuitry 120. Additionally, smart mirror 100 may include a secure digital (SD) memory card 710 to increase the memory capacity of SBC 720 and a USB microphone 715 as microphone 117. LED monitor 705 may have associated hardware, such as a reflective overlay 725 as reflective overlay 105, an HDMI port 730, an enclosure 735 as enclosure 112, a wooden frame 740 as frame 210 and cables 745 as cables 215 and 220. SBC 720 may have associated hardware, such as an Ethernet port 750, wireless LAN adapter 755, random access memory (RAM) 760, a central processing unit (CPU) 750, an operating system (OS) 770, a camera interface 775, a USB port 780, a card slot 785 in which to accept SD card 710 and an HDMI port 790.

FIG. 8 is an architectural abstraction diagram of smart mirror 100. As illustrated in the figure, smart mirror 100 can be viewed as comprising a hardware space 810, a kernel space 820, an operating system space 830, an application space 840 and a user space 850. These spaces are abstracted in a plurality of layers, where the components of lower layers are only accessible by components of upper layers.

Hardware space 810 contains a collection of major physical hardware components of SBC 720 including monitor 705, wireless LAN adapter 755, USB microphone 715, CPU 765, USB port 780 and memory 710, 760. These components are only accessible through upper layers and do not accept direct user access. For example, commands through USB microphone 715 occur through dashboard 500 in user space 850 and pass through the other layers before being accepted by CPU 765.

Kernel space 820 is a low-level layer containing kernel driver 822. Kernel driver 822 is the application software (dashboard 500, etc.) to the hardware of smart mirror 100 and is loaded on start-up (after the bootloader). It handles the rest of start-up as well as input/output requests from software components, translating them into data-processing instructions for CPU 765. It handles memory and peripherals like monitor 705 and microphone 715.

OS space 830 contains the operating system, which in the illustrated example is the LINUX-DEBIAN operating system, which manages user and other tasks executing on resources in kernel space 820 and hardware space 810.

Application space 840 contains the application level operations, e.g., the smart mirror software. Application space 840 may contain, for example, a voice recognition process 842, such as through the ANNYANG voice recognition package, source code 844, libraries 845, APIs 846, JAVASCRIPT 848 and a web browser 849. Web browser 849 may work in conjunction with voice recognition process 842 to translate voice commands into text for command processing. Additionally, web browser 849 may be utilized to realize dashboard 500 and interactive charts and graphics implemented by JAVASCRIPT and associated APIs 846 and libraries 845.

User space 852 is the only space that is visible to the user and contains dashboard 500. The user can view dashboard 500 and interact therewith through voice commands on microphone 715.

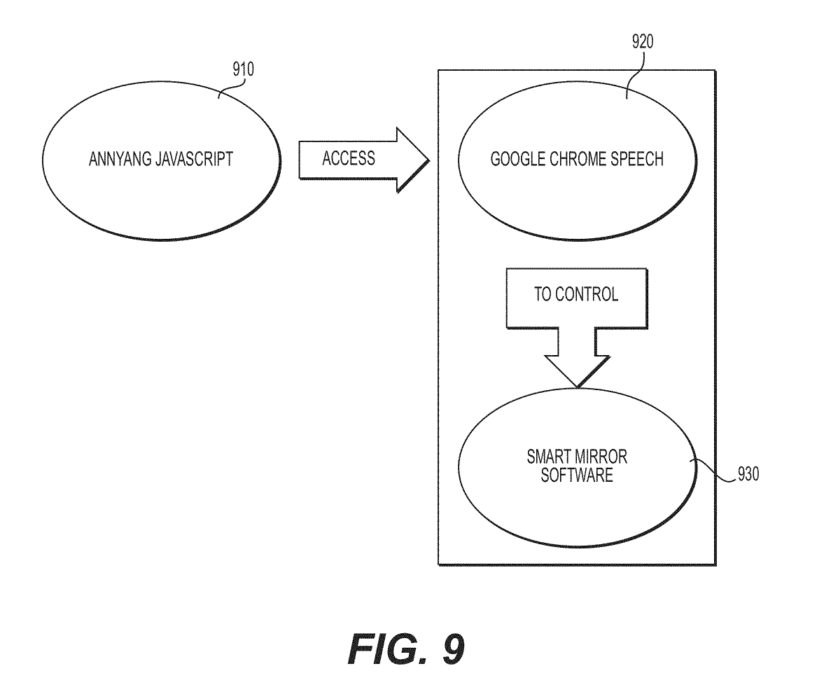

FIG. 9 is a block diagram illustrating example voice recognition process 900 that can be used in conjunction with embodiments of the present invention. As indicated above, embodiments of the invention utilize ANNYANG, which is a small, lightweight JAVASCRIPT library that allows front-end users to control operations of smart mirror 100 using vocal commands. ANNYANG supports several languages and works with all browsers to progressively enhance the performance of those browsers that support speech recognition. ANNYANG relies on the browser's own speech recognition engine to process voice commands. For example, in the GOOGLE CHROME browser, the ANNYANG JAVASCRIPT library 910 accesses the GOOGLE CHROME speech engine 920 to control smart mirror software 930.

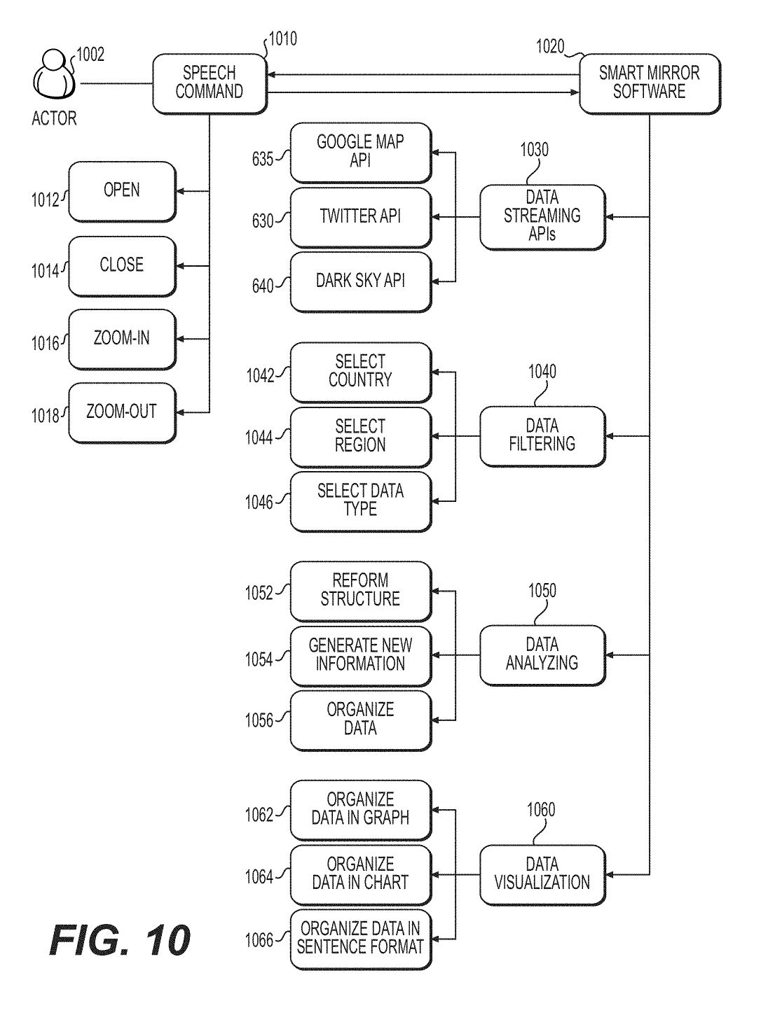

FIG. 10 is a block diagram hierarchically depicting certain processes and their features. Actor 1002 symbolizes any general user issuing recognized speech commands 1010, such as open command 1012, close command 1014, zoom-in command 1016 and zoom-out command 1018. Commands 1010 may be processed by smart mirror software 1020 (processor instructions executing on SBC 720), which contains four (4) primary sub-processes: data streaming APIs 1030, data filtering process 1040, data analyzing process 1050 and data visualization process 1060. Data streaming APIs 1030 may include GOOGLE MAP API 635, TWITTER API 630 and DARK SKY API 640 among others. Data filtering process 1040 may allow the user to select a country in operation 1042, select a region in operation 1044 and select a data type in operation 1046. Data analyzing process 1050 may reform the structure of the received data in operation 1052, generate new information (e.g., statistics) in operation 1054 and organize the data according to some criteria in operation 1056. Data visualization process 1060 may organize the analyzed data into a graph in operation 1062, into a chart in operation 1064 and may organize the analyzed data in textual format in operation 1066.

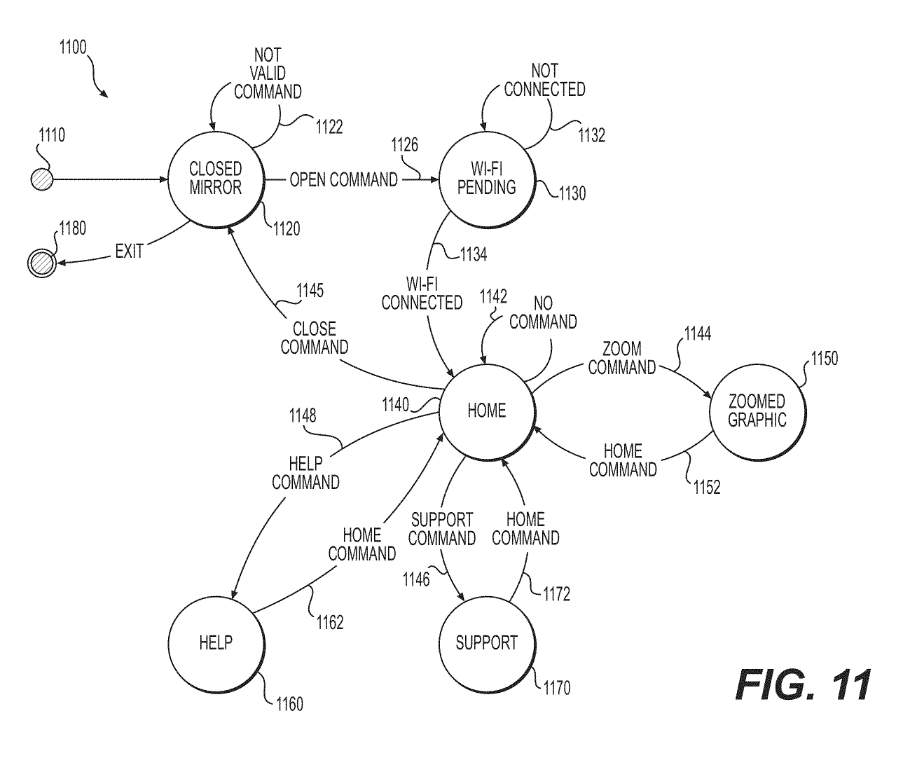

FIG. 11 is a state diagram of an exemplary state machine 1100 by which the present invention can be embodied. Example state machine 1100 is instantiated in an initial state 1110 and transitions into closed mirror state 1120. As indicated at 1122, state machine 1100 will remain in closed mirror state 1120 until a valid user command is received. When such has been issued, as indicated at open command event 1126, state machine 1100 may transition to Wi-Fi pending state 1130. State machine 1100 may remain in Wi-Fi pending state 1130, as indicated at 1132, until a Wi-Fi connected event 1134, at which point state machine 1100 may transition to home state 1140. In home state 1140, dashboard 610 may be displayed in its home state according to user preferences and state machine 1100 will remain in home state 1140 as long as no command is received, as indicated at 1142. Upon a zoom command event 1144, state machine 1100 may transition into zoomed graphic state 1150, in which the graphic indicated in the command is zoomed in and given prominence on dashboard 610. State machine 1100 may transition from zoomed graphic state 1150 to home state 1140 responsive to a home command event 1152. Upon a help command event 1148, state machine 1100 may transition into help state 1160, in which a help screen, such as help interface 506, is given prominence on dashboard 610. State machine 1100 may transition from help state 1160 to home state 1140 responsive to a home command event 1162. Upon a support command event 1146, state machine 1100 may transition into support state 1170, in which a support screen, such as support interface 508, is given prominence on dashboard 610. State machine 1100 may transition from support state 1170 to home state 1140 responsive to a home command event 1172. State machine 1100 may transition to closed mirror state 1120 upon a close mirror event 1145 and may transition from closed mirror state 1120 to final state 1180 responsive to an exit event 1124, such as controlled by a sleep timer or similar control.

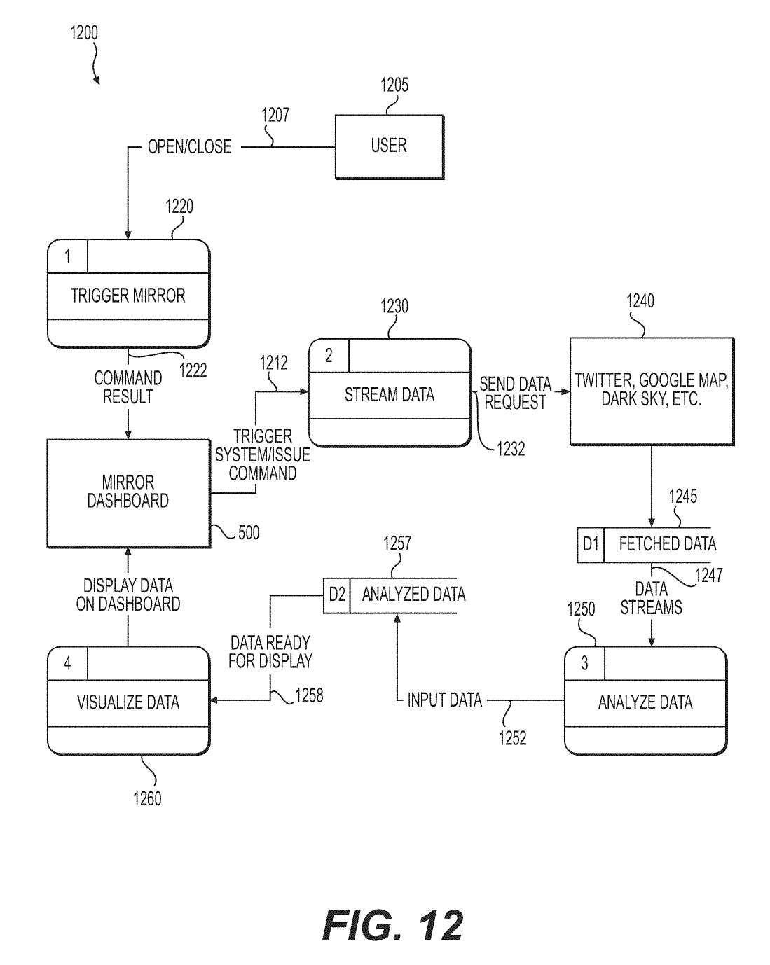

FIG. 12 is a flow diagram of example processes of process 1200 by which the present invention can be embodied. As is illustrated in the figure, user 1205 vocalizes or otherwise issues an open or close command 1207 which is received by trigger mirror process 1220 which issues the appropriate command result to dashboard 500. Dashboard 500 may then trigger the system and issue suitable commands, as indicated at 1212, to stream data process 1230. Stream data process 1230 may send suitably formatted data requests 1232 to the APIs of respective information services 1240, e.g., TWITTER, GOOGLE MAPS, DARK SKY, etc. Data are retrieved and stored in a temporary data file Fetched Data 1245 and provided in data streams 1247 to analyze data process 1250. Analyze data process 1250 selects, filters, manages and organizes groups of data, input data 1252, which may be stored in a temporary data file Analyzed Data 1257. Data that have been analyzed and ready for display 1258 are provided to visualize data process 1260, whereby the data are organized, arranged, formatted, etc., into charts, diagrams, graphs, text, etc., and provided as display data 1262 for mirror dashboard 610, where it can be viewed by user 1205.

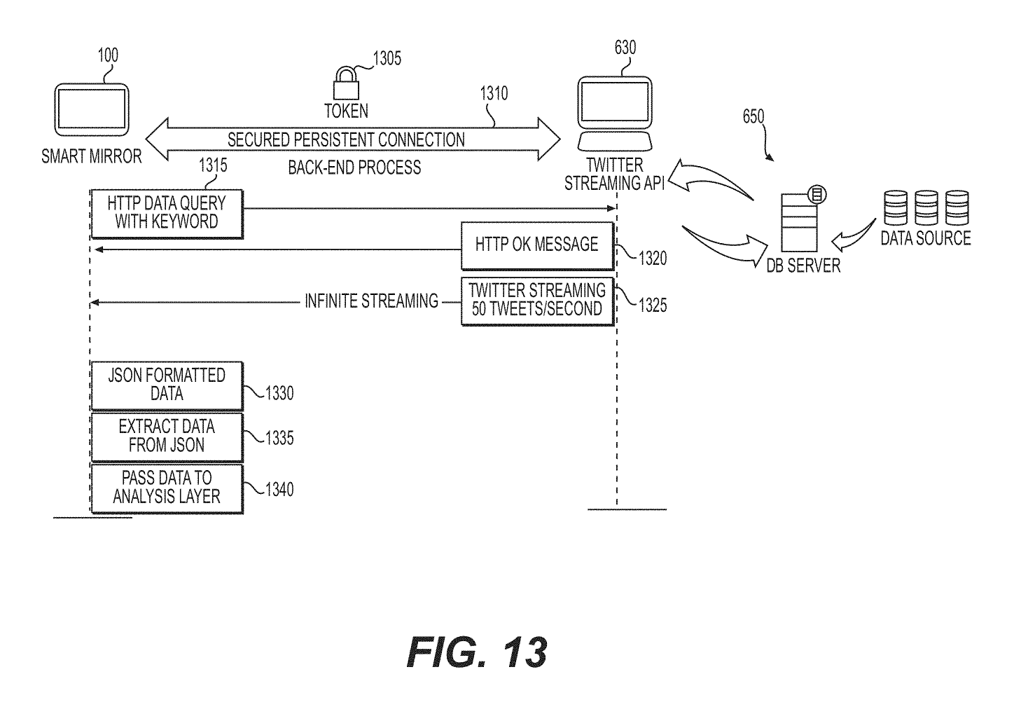

FIG. 13 is a diagram illustrating communications of smart mirror 100 with an information service, e.g., TWITTER, through its API 630. Smart mirror 100 may utilize TWITTER's streaming API which realizes a persistent connection 1310 secured by a token 1305 to continuously feed the smart mirror dashboard with new, updated data. In operation 1315, smart mirror 100 may convey a data query using a keyword via HTTP. In response, API 630 may convey a HTTP OK message to smart mirror 100 in operation 1320 and begin transmitting an infinite stream of data in operation 1325. Smart mirror 100 receives the stream of data in JSON format in operation 1330 and extracts data therefrom in operation 1335. The extracted data are passed to data analysis layer 420 in operation 1340.

Smart mirror will connect to TWITTER streaming API via HTTP request, which allows smart mirror software to consume the resulting stream for as long as possible. TWITTER servers will hold the connection open indefinitely (persistent connection). It pushes data to the client as and when it is available. There is no need for the client to poll the requests to the server for newer data. The connection is triggered by client request. Connection will continue unless there is a problem with HTTP server, such as a loss of Internet connection. Using streaming API ensures a persistent connection to smart mirror software.

Creating HTTP requests is different from one language to another, but the similarity between them is that each request is authorized using OAuth. OAuth ensures secure access to TWITTER API without the need of sharing credentials to a third party. Smart mirror 100 may use application-only authentication which gives the software the ability to access data that doesn't need user credential like “search in tweets.” The public streaming API offers the choice of collecting and reading public data, account, keywords via one connection. The connection starts by sending a first query, then the API will continuously push data in JSON format to the client.

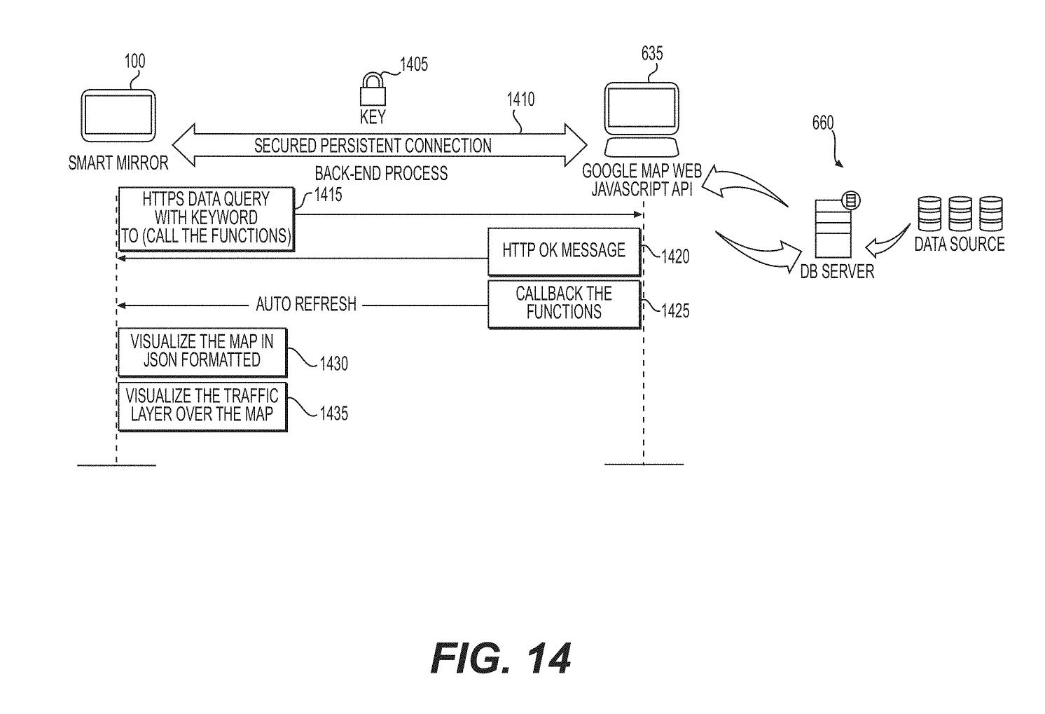

FIG. 14 is a diagram illustrating communications of smart mirror 100 with an information service, e.g., GOOGLE MAPS, through its API 635. Smart mirror 100 may utilize GOOGLE MAP's API through a persistent connection 1410 secured by a key 1405. GOOGLE MAPS web service includes a collection of HTTP interfaces to GOOGLE services that provide geographic data for map applications. In certain embodiments, smart mirror 100 implements callback functions in JAVASCRIPT using the JAVASCRIPT API. In operation 1415, smart mirror 100 may convey a data query with a keyword and the callback functions to API 635 over HTTPS. In response, API 635 may convey an HTTPS OK message to smart mirror 100 in operation 1420. API 635 may process the functions and send a data package in operation 1425, where the package automatically refreshes. In operation 1430, the map is rendered in JSON format and, in operation 1435, traffic patterns are rendered over the rendered map.

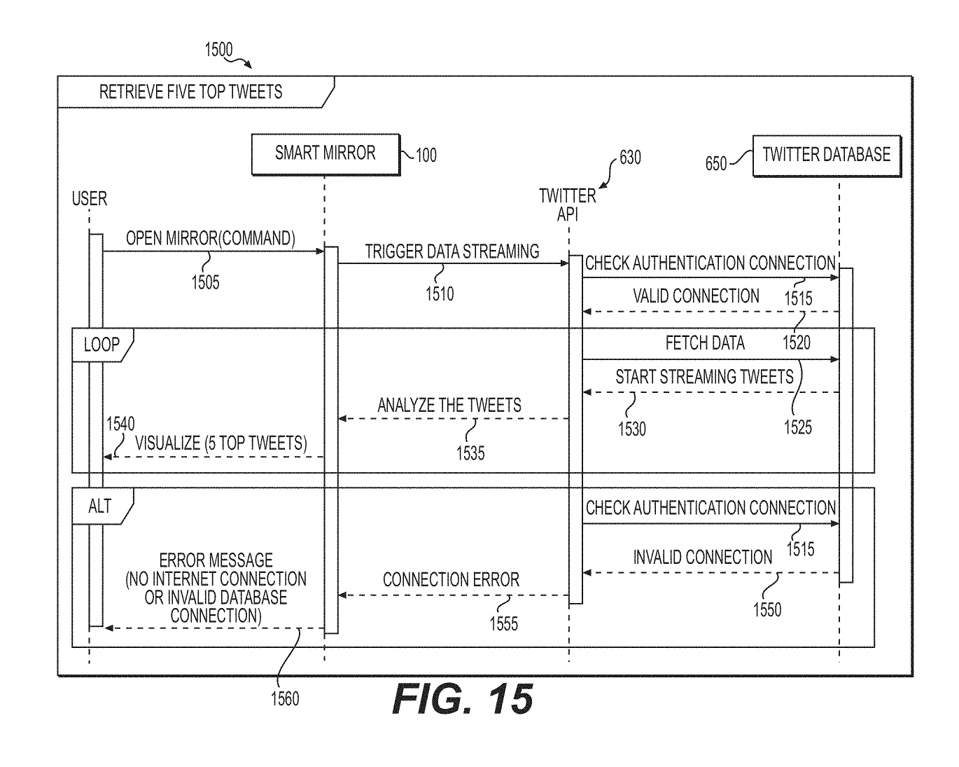

FIG. 15 is a sequence diagram of a process 1500 by which the top five (5) tweets are retrieved from TWITTER database 650 through TWITTER API 630. In operation 1505, the user may issue an open mirror command and a trigger to begin data streaming is conveyed to API 630 in operation 1510. In operation 1515, API 630 determines whether a properly authenticated connection is established and, if so, an indication of such is conveyed to API 630 in operation 1520. In a continuous loop, data are fetched from database 650 in operation 1525 and, in operation 1530, tweets are streamed via API 630. In operation 1535, the tweets are analyzed and in operation 1540, the visualized tweet data are displayed to the user.

In the alternative, should an invalid connection be determined at operation 1515, an indication of such is provided in operation 1550. API 630 may indicate a connection error in operation 1555 and smart mirror 100 may render an error message to the user in operation 1560.

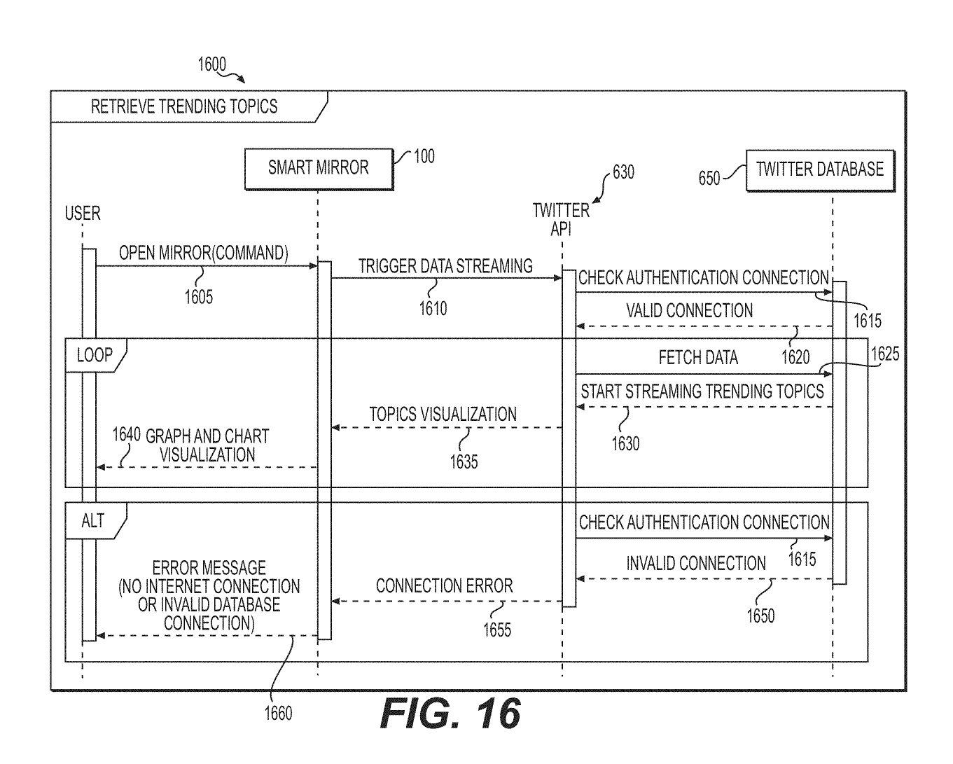

FIG. 16 is a sequence diagram of a process 1600 by which trending topics are retrieved from TWITTER database 650 through TWITTER API 630. In operation 1605, the user may issue an open mirror command and a trigger to begin data streaming is conveyed to API 630 in operation 1610. In operation 1615, API 630 determines whether a properly authenticated connection is established and, if so, an indication of such is conveyed to API 630 in operation 1620. In a continuous loop, data are fetched from database 650 in operation 1625 and, in operation 1630, topics are streamed via API 630. In operation 1635, the topics are rendered into graphs and in operation 1640, the visualized topic data are displayed to the user.

In the alternative, should an invalid connection be determined at operation 1615, an indication of such is provided in operation 1650. API 630 may indicate a connection error in operation 1655 and smart mirror 100 may render an error message to the user in operation 1660.

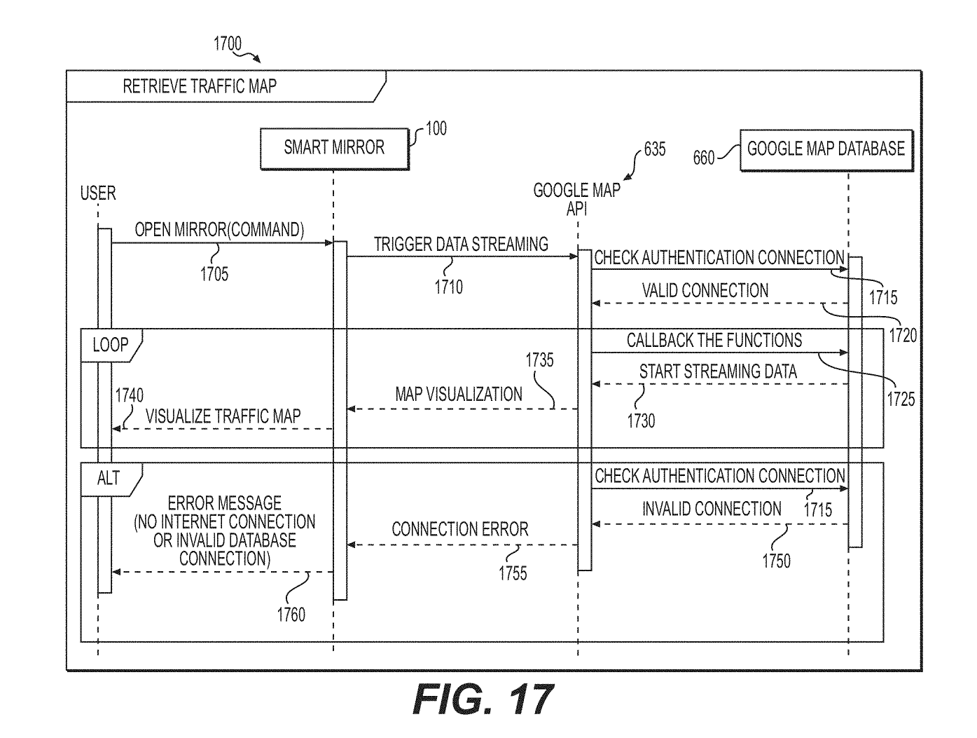

FIG. 17 is a sequence diagram of a process 1700 by which traffic maps are retrieved from GOOGLE MAPS database 660 through GOOGLE MAPS API 635. In operation 1705, the user may issue an open mirror command and a trigger to begin data streaming is conveyed to API 635 in operation 1710. In operation 1715, API 635 determines whether a properly authenticated connection is established and, if so, an indication of such is conveyed to API 635 in operation 1720. In a continuous loop, API 635 retrieves data through callback functions in operation 1725 and, in operation 1730, map and traffic data are streamed via API 635. In operation 1735, the maps are rendered and in operation 1740, the visualized map and traffic data are displayed to the user.

In the alternative, should an invalid connection be determined at operation 1715, an indication of such is provided in operation 1750. API 635 may indicate a connection error in operation 1755 and smart mirror 100 may render an error message to the user in operation 1760.

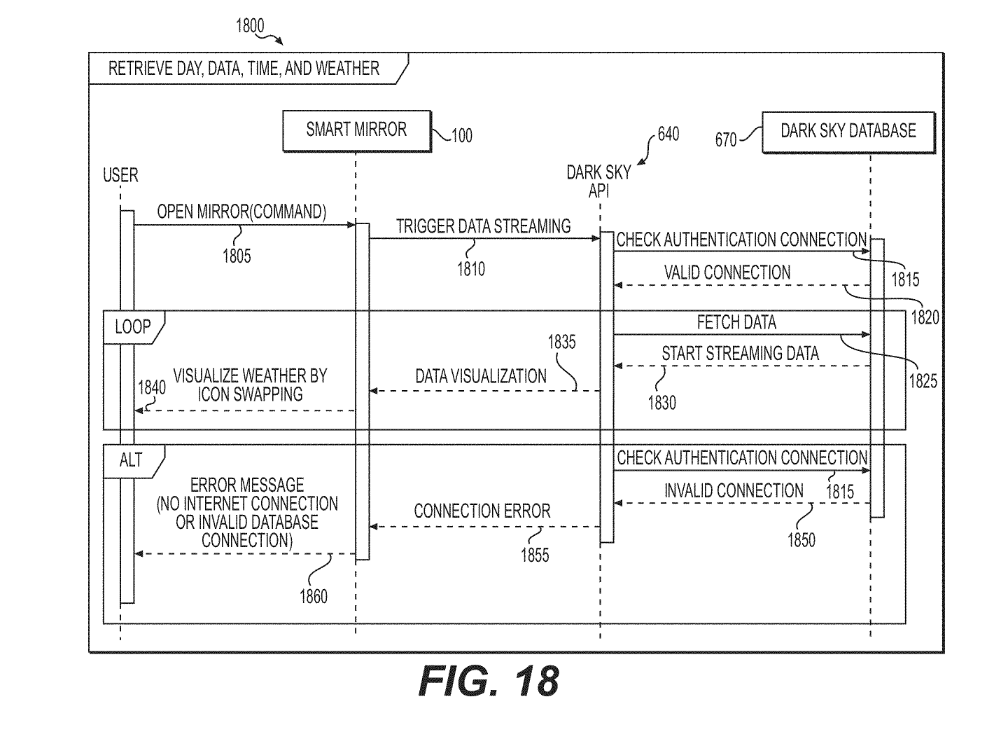

FIG. 18 is a sequence diagram of a process 1800 by which day, date, time and weather data are retrieved from DARK SKY database 670 through DARK SKY API 640. In operation 1805, the user may issue an open mirror command and a trigger to begin data streaming is conveyed to API 640 in operation 1810. In operation 1815, API 640 determines whether a properly authenticated connection is established and, if so, an indication of such is conveyed to API 640 in operation 1820. In a continuous loop, data are fetched from database 670 in operation 1825 and, in operation 1830, time, date and weather data are streamed via API 640. In operation 1835, the data are analyzed and in operation 1840, the visualized tweet data are displayed to the user.

In the alternative, should an invalid connection be determined at operation 1815, an indication of such is provided in operation 1850. API 640 may indicate a connection error in operation 1855 and smart mirror 100 may render an error message to the user in operation 1860.

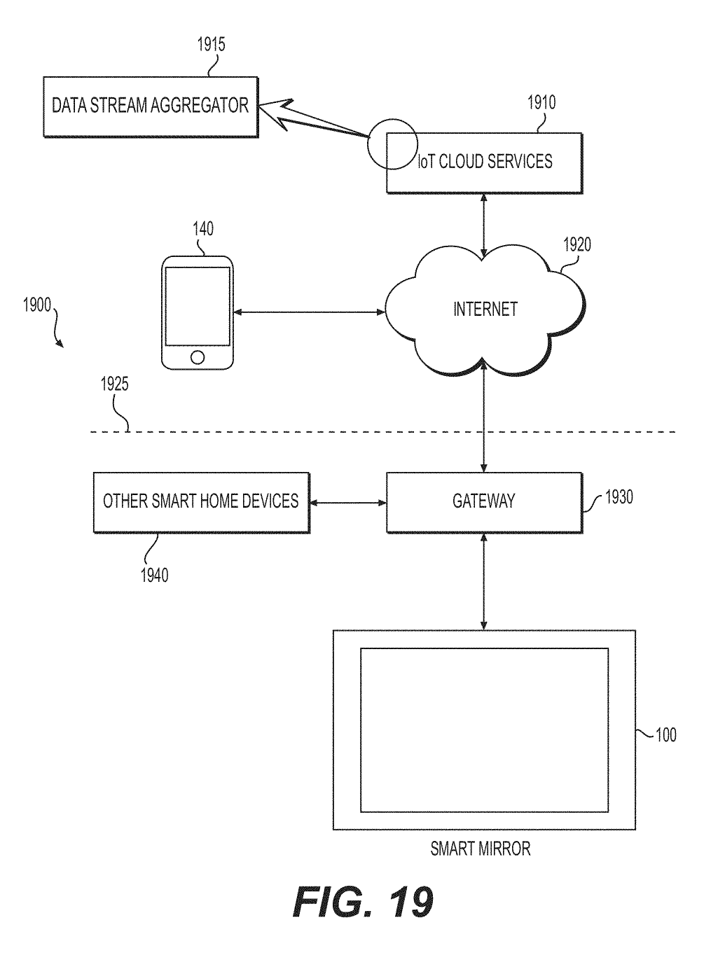

As indicated above, smart mirror 100 may be an entity on IoT, such as when smart mirror 100 is a component of a smart home. FIG. 19 is a schematic block diagram of a smart home system 1900 in which smart mirror 100 is a component. As illustrated in FIG. 19, smart mirror 100 may reside in a structure, such as a building, illustrated by the boundary 1925, behind a suitable gateway 1930 along with other smart home devices 1940 (thermostats, lighting controls, appliances, etc.). Access to smart mirror 100 may be achieved via a connection through Internet 1920 and gateway 1930. Those skilled in the smart home and IoT technologies will recognize from the foregoing that smart home system 1900 is conventional and will fully understand its operation without specific implementation details thereof. Such implementation details will thus be omitted in the interest of conciseness except where such detail will enhance comprehension of the present invention. It is to be understood, however, that the present invention is not limited to specific smart home architecture or to specific components to carry out the operations of smart home system 1900. The aforementioned skilled artisans will recognize numerous IoT configurations in which the present invention can be implemented upon review of this disclosure

IoT cloud services 1910 may be a managed cloud platform that lets connected devices easily and securely interact with cloud applications and other devices. IoT cloud services 1910 may support numerous devices and messages, and can process and route those messages to devices reliably and securely. In certain embodiments, IoT cloud services 1910 include a data stream aggregator service 1915 that aggregates the data from the separate APIs 320 into a data stream over a single persistent connection. A user may access data aggregator service 1915 from, for example, smartphone 140 to establish which information services 160 are to be included in the data aggregation, where only the data in the aggregation are rendered on smart mirror 100.

The storage areas and memory circuitry described herein may be implemented by any quantity of any type of conventional or other memory or storage device, and may be volatile (e.g., RAM, cache, flash, etc.), or non-volatile (e.g., ROM, hard-disk, optical storage, etc.), and include any suitable storage capacity. The storage areas may be, for example, one or more databases implemented on a solid state drive or in a RAM cloud.

Processor circuitry described herein is, for example, one or more data processing devices such as microprocessors, microcontrollers, systems on a chip (SOCs), or other fixed or programmable logic, that executes instructions for process logic stored the memory. The processors may themselves be multi-processors, and have multiple CPUs, multiple cores, multiple dies comprising multiple processors, etc.

Client devices, such as data processing device 140, may be any conventional or other computer system or device, such as a thin client, computer terminal or workstation, personal desktop computer, laptop or netbook, tablet, cellular phone, networked television, or other device capable of acting as a client.

The communications circuitry described herein are communicatively connected to each other, for example, via a network, and represent any hardware and/or software configured to communicate information via any suitable communications media (e.g., WAN, LAN, Internet, Intranet, wired, wireless, etc.), and may include routers, hubs, switches, gateways, or any other suitable components in any suitable form or arrangement. The various components of the system may include any conventional or other communications devices to communicate over the networks via any conventional or other protocols, and may utilize any type of connection (e.g., wired, wireless, etc.) for access to the network.

The system may include additional servers, clients, and other devices not shown, and individual components of the system may occur either singly or in multiples, or for example, the functionality of various components may be combined into a single device or split among multiple devices. It is understood that any of the various components of the system may be local to one another, or may be remote from and in communication with one or more other components via any suitable means, for example a network such as a WAN, a LAN, Internet, Intranet, mobile wireless, etc.

I/O circuitry 122 enables communication between display device 110 and the other components of smart mirror 100, and may enable communication with these devices in any suitable fashion, e.g., via a wired or wireless connection. The display device 110 may be any suitable display, screen or monitor capable of displaying information to a user of smart mirror 100. I/O circuitry 122 may also connect to input devices, which may include any suitable input device, for example, a keyboard, mouse, trackpad, touch input tablet, touch screen, camera, microphone, remote control, speech synthesizer, or the like. I/O circuitry 122 may also connect to output devices, which may include any suitable output device, for example, a speaker, headphone, sound output port, or the like. The display device 110, input device(s) and output device(s) may be separate devices, e.g., a monitor used in conjunction with a microphone and speakers, or may be combined, e.g., a touchscreen that is a display and an input device, or a headset that is both an input (e.g., via the microphone) and output (e.g., via the speakers) device.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuitry,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a solid state disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, a phase change memory storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, e.g., an object oriented programming language such as Java, Smalltalk, C++ or the like, or a conventional procedural programming language, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

It is to be understood that the software for the computer systems of the present invention embodiments may be implemented in any desired computer language and could be developed by one of ordinary skill in the computer arts based on the functional descriptions contained in the specification and flow charts illustrated in the drawings. By way of example only, the software may be implemented in the C++, Java, Fortran or other programming languages. Further, any references herein of software performing various functions generally refer to computer systems or processors performing those functions under software control.

The computer systems of the present invention embodiments may alternatively be implemented by any type of hardware and/or other processing circuitry. The various functions of the computer systems may be distributed in any manner among any quantity of software modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

A processing system suitable for storing and/or executing program code may be implemented by any conventional or other computer or processing systems preferably equipped with a display or monitor, a base (e.g., including the processor, memories and/or internal or external communications devices (e.g., modem, network cards, etc.) and optional input devices (e.g., a keyboard, mouse or other input device)). The system can include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the system to become coupled to other processing systems or remote printers or storage devices through intervening private or public networks. Modems, cable modem and Ethernet cards are just a few of the currently available types of network adapters.

The flowchart and block diagrams in the figures illustrate the architecture, functionality, and operation of possible implementations of systems, method and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending on the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. The example embodiments were chosen and described in order to best explain the principles of the invention and the practical application, and to enable others of ordinary skill in the art to understand the invention for various embodiments with various modifications as are suited to the particular use contemplated.

The descriptions above are intended to illustrate possible implementations of the present inventive concept and are not restrictive. Many variations, modifications and alternatives will become apparent to the skilled artisan upon review of this disclosure. For example, components equivalent to those shown and described may be substituted therefore, elements and methods individually described may be combined, and elements described as discrete may be distributed across many components. The scope of the invention should therefore be determined not with reference to the description above, but with reference to the appended claims, along with their full range of equivalents.

1. A mirror apparatus comprising:
a reflective panel having a front surface and an opposing back surface;
a display device facing the back surface of the reflective panel such that information rendered thereon is conveyed to the front surface of the reflective panel;
processor circuitry configured to:
accept a voice command from a user; and
render the information on the display in accordance with constraints of an interface selected based on the voice command.

2. The apparatus of claim 1, wherein the processor is further configured to:
determine whether the voice command is valid;
constrain the information to an error message upon determination that the voice command is invalid; and
render the information on the display through an error interface.

3. The apparatus of claim 2, further comprising communications circuitry configured to communicatively couple to at least one information service through a communications network.

4. The apparatus of claim 3, wherein the processor is further configured to:
obtain the information from the information service through the communications circuitry; and
render the obtained information on the display upon determination that the voice command is valid.

5. The apparatus of claim 3, wherein the processor is further configured to:
analyze the data from the information service;
select a visualization of the data based on the analysis; and
format the data as the information in accordance with the visualization thereof.

6. The apparatus of claim 1, further comprising an immutable identifier by which the apparatus is identified as an entity on the Internet.

7. The apparatus of claim 6, wherein the processor is further configured to:
accept configuration information through the communications circuitry from an external device communicatively coupled to the communications network; and
obtain the data from only information services specified in the configuration information.

8. A method comprising:
accepting a voice command from a user of a mirror apparatus comprising:
a reflective panel having a front surface and an opposing back surface;
a display device facing the back surface of the reflective panel such that information rendered thereon is conveyed to the front surface of the reflective panel;
rendering the information on the display in accordance with constraints of an interface selected based on the voice command.

9. The method of claim 8 further comprising:
determining whether the voice command is valid;
constraining the information to an error message upon determination that the voice command is invalid; and
rendering the information on the display through an error interface.

10. The method of claim 9 further comprising:
obtaining the information from an information service through a communications network; and
rendering the obtained information on the display upon determination that the voice command is valid.

11. The method of claim 10 further comprising:
analyzing the data from the information service;
selecting a visualization of the data based on the analysis; and
formatting the data as the information in accordance with the visualization thereof.

12. The method of claim 10 further comprising:
immutably identifying the mirror apparatus as an entity on the Internet.

13. The method of claim 12 further comprising:
accepting configuration information from an external device communicatively coupled to a communications network; and
obtaining the data from only information services specified in the configuration information.

14. A computer-readable medium having processor instructions encoded thereon that, when executed by the processor, compels the processor to:
accept a voice command from a user of a mirror apparatus comprising:
a reflective panel having a front surface and an opposing back surface;
a display device facing the back surface of the reflective panel such that information rendered thereon is conveyed to the front surface of the reflective panel;
render the information on the display in accordance with constraints of an interface selected based on the voice command.

15. The computer-readable medium of claim 14 having additional processor instructions encoded thereon that compel the processor to:
determine whether the voice command is valid;
constrain the information to an error message upon determination that the voice command is invalid; and
render the information on the display through an error interface.

16. The computer-readable medium of claim 15 having additional processor instructions encoded thereon that compel the processor to:
obtain the information from an information service through a communications network; and
render the obtained information on the display upon determination that the voice command is valid.

17. The computer-readable medium of claim 16 having additional processor instructions encoded thereon that compel the processor to:
analyze the data from the information service;
select a visualization of the data based on the analysis; and
format the data as the information in accordance with the visualization thereof.

18. The computer-readable medium of claim 16 having additional processor instructions encoded thereon that compel the processor to:
immutably identify the mirror apparatus as an entity on the Internet.

19. The computer-readable medium of claim 18 having additional processor instructions encoded thereon that compel the processor to:
accept configuration information from an external device communicatively coupled to a communications network; and
obtain the data from only information services specified in the configuration information.
